(19) United States
(12) Patent Application Publication
(10) Pub. No.: US 2013/0079434 A1
(43) Pub. Date: Mar. 28, 2013

(54) PROCESS FOR MANUFACTURING A PART MADE OF A COMPOSITE HAVING A HOLLOW CORE

(71) Applicants: Societe Lorraine de Construction Aeronautique, Frorange (FR); Arts & Metiers Paris Tech, Metz (FR); Ateliers Cini, Tomblaine (FR); Pole de Plasturgie de L'EST, Saint Avold (FR)

(72) Inventors: Florence CASTAGNET, VELIZY-VILLACOUBLAY (FR); Hervé HURLIN, IGNY (FR); Patrick MARTIN, VILLERS-les-NANCY (FR); Alain D'ACUNTO, SAINT BARBE (FR); Marius MIHALUTA, METZ (FR); Henri-François PERRIN, PONTOY (FR); Louis BETTEGA, BOUCHEPORN (FR); Jean-Pierre CAUCHOIS, OBERSTEINBACH (FR); Jérome CINI, LAITRE s/s AMANCE (FR); Richard MANGENOT, BATTIGNY (FR)

(73) Assignees: Societe Lorraine de Construction Aeronautique, Frorange (FR); Pole de Plasturgie de L'EST, Saint Avold (FR); Ateliers Cini, Tomblaine (FR); Arts & Metiers Paris Tech, Metz (FR)

(21) Appl. No.: 13/674,814

(22) Filed: Nov. 12, 2012

Related U.S. Application Data
(63) Continuation of application No. PCT/FR2011/050962, filed on Apr. 28, 2011.

(30) Foreign Application Priority Data
May 11, 2010 (FR) 10/53667

(51) Int. Cl. B29C 65/48; C09J 201/00

(52) U.S. Cl. CPC B29C 65/486; C09J 201/00
USPC 523/218; 156/60; 156/285

(57) ABSTRACT

A method for manufacturing a part in composite material with a hollow core is provided that includes applying at least one adhesive layer on an open surface of the hollow core. The adhesive layer is a blocking polymerizable adhesive layer having, after polymerization, sealing properties relatively to a resin and capable of preventing its diffusion towards an inside of the hollow core. Subsequently, the blocking adhesive layer is polymerized so as to achieve sealing of the hollow core. Additionally, various parts manufactured according to the methods of the present disclosure are also provided.

### CROSS-REFERENCE TO RELATED APPLICATIONS

This application is a continuation of International Application No. PCT/FR2011/050962 filed on Apr. 28, 2011, which claims the benefit of FR 10/53667, filed on May 11, 2010. The disclosures of the above applications are incorporated herein by reference.

### FIELD

The present disclosure relates to a method for manufacturing parts in composite material by resin transfer molding.

Several known molding methods by impregnation of fibers with resin may be used for making parts in composite material and notably, molding methods using closed molds.

Firstly, mention may be made of the resin transfer molding method or RTM for [symbol] Resin Transfer Molding [symbol] .

In the RTM method, a set of fibrous elements is positioned in a particular way around a support and the set is placed inside a closed mold, the general shape of which corresponds to that of the part to be made.

In the traditional RTM method, this mold consists of a female mold or matrix and of a counter-mold or punch portion.

A resin is then injected into the mold and it is then polymerized. The molecules of this resin then begin to bind together and form a solid network. A rigid part in composite material formed with fibers and polymerized resin is thereby obtained.

Mention may also be made of the resin infusion molding method or LRI (Liquid Resin Infusion).

Generally, such a method applies several steps among which is included the placement of fibrous reinforcing elements on the shape of a mold.

The mold is then closed via a flexible lid allowing the controlled passing of a resin which will infuse inside fibrous reinforcing elements and then polymerize, in order to give a rigid part.

The propagation of the resin is accomplished by a driving force generated by a depression in certain points of the flexible lid, towards which the resin introduced into the mold moves.

In the traditional infusion method, the molding tooling is thus formed with a matrix mold and a leakproof lid such as a tarpaulin as a counter-mold part.

Composite parts intended for aeronautical construction require maximum mechanical performances for masses as low as possible.

A solution to these requirements is the use of composite materials as described earlier, with an open cell core, notably of the honeycomb type.

The use of such a core inside a composite part has very good mechanical characteristics for the field of application, and this notably in compression, for low densities.

These products are widely used in the aeronautical industry and their application is made possible by the use of fabrics pre-impregnated with resin.

Indeed, the resin already present in the fibers is unable to migrate or able to only moderately migrate into the open cells of the core.

However, the development of manufacturing methods by resin transfer, as described earlier, would allow further optimization of the manufacturing of such composite parts an open cell cellular core.

Unfortunately, an obstacle to the use of the resin transfer methods for manufacturing such parts lies in the fact that the resin tends to penetrate inside the cells of the core. This phenomenon is not desirable since it increases the consumption of resin, makes the structure heavy and decreases the performances of the cellular structure, among other drawbacks.

Documents EP 1 795 332 and EP 1 897 680 propose a solution to this problem.

Each of these documents uses an obturating intermediate layer arranged between the cellular core and the fibrous layers, said obturating layer preventing migration of the resin towards the cells of the core on the one hand and at least one adhesive layer aimed at ensuring good cohesion of the fibrous layers and of the cellular core on the other hand.

More specifically, document EP 1 005 978 describes a method for manufacturing a composite material with a cellular core comprising the steps aimed at:
applying a first adhesive layer on an open surface of the cellular core,
applying a solid film on the adhesive layer,
applying a second adhesive layer on the outer surface of the solid film,
arranging the set of fibrous layers on the second adhesive layer,
applying the resin according to an RTM method and proceeding with its polymerization.

Document EP 1 897 680 is also directed to a method for manufacturing a composite material with a cellular core comprising the steps aimed at:
setting into place a curable adhesive layer on at least one open surface of the cellular core,
setting into place a blocking layer on the adhesive layer,
setting into place fibrous layers,
applying the resin according to a vacuum infusion method.

These methods however require a significant number of intermediate layers (adhesive blocking, layers . . . ), which also makes the application of the manufacturing method relatively complex.

### BACKGROUND

The statements in this section merely provide background information related to the present disclosure and may not constitute prior art.

### SUMMARY

The present invention includes a method for manufacturing a part in composite material with a hollow core comprising the following steps aimed at:
applying at least one adhesive layer on an open surface of the hollow core, said method being characterized in that the adhesive layer is a blocking polymerizable adhesive layer having after polymerization, sealing properties relatively to a resin and capable of preventing its diffusion towards the inside of the hollow core,
proceeding with polymerization of the blocking adhesive layer so as to produce the seal of the hollow core.

Thus, by using an adhesive layer capable of also having blocking properties for the resin, it is possible to seal the hollow core and avoid the filling of the core with the resin during subsequent treatment processes.

Preferentially, the blocking adhesive layer is a supported adhesive ply.

Still advantageously, the blocking adhesive layer is supported by a weft of polymer or glass fibers.

Preferentially, the sealing characteristics are obtained by intimate assembling of the adhesive plies with the adjacent fibers.

Preferentially, a pressure force is applied at least on the adhesive layer along a direction perpendicular to the latter.

Indeed, it was surprisingly seen that the application of a pressure force on the adhesive ply in a direction strictly perpendicular to the latter gave the possibility of considerably increasing the sealing properties towards the resin.

According to one form of the present disclosure, the pressure force is applied by applying vacuum to the assembly to be sealed.

In one form, vacuum application is carried out by means of at least one flexible or semi rigid membrane being used as a counter mold.

Advantageously, the pressure force is applied on the adhesive layer via at least one draining layer.

The presence of a draining layer allows uniformization of the applied pressure force. This aims at limiting the collapse of the adhesive layer inside the hollow core and avoiding degradation of its sealing performances by heterogeneously distributing the adhesive thickness of the adhesive layer due to local overpressures which have to be avoided.

In a complementary manner, the method comprises an additional step aiming at applying onto the adhesive layer at least one ply of fibers. This additional step gives the possibility of making a preform of the composite parts with a sealed hollow core.

Advantageously, the ply of fibers comprises at least one ply of nonwoven fibers, notably carbon fibers, having homogeneous permeability at the fibers. By inserting such a nonwoven ply, it is possible to avoid the formation of preferential take-up points. This also limits the migration of the adhesive towards the plies of dry fibers during its polymerization cycle and contributes to the improvement of the mechanical properties of the composite skin core interface.

According to one form of the present disclosure, the ply of fibers is a ply of dry fibers.

In a complementary manner, the method comprises an additional step aiming at applying resin according to a molding method by resin transfer and proceeding with the polymerization of said resin in the same casing. Thus, the application times of this method are strongly reduced. In this case, a single stack allows the making of the preform, associated with a specific baking cycle, the polymerization of the adhesive layer, associated with its polymerization or pre polymerization cycle, the carrying-out of the impregnation of the preform with the resin, associated with its specific polymerization cycle.

According to an alternative form of the present disclosure, the method comprises an intermediate additional step aiming at pre-forming the plies of fibers.

The present disclosure also relates to a part in composite material which may be obtained by a method according to the invention. Said part may be the finished and complete composite material part or else an intermediate part such as a sealed hollow core, a preform of fibrous plies and a sealed core.

Advantageously, the hollow core is a cellular core, notably of the honeycomb type. However this may also be another type of hollow core or even a combination of cores of diverse natures.

Further areas of applicability will become apparent from the description provided herein. It should be understood that the description and specific examples are intended for purposes of illustration only and are not intended to limit the scope of the present disclosure.

### DRAWINGS

The present disclosure will be better understood in the light of the detailed description which follows, with reference to the appended drawings wherein:

FIG. 1 schematically illustrates the application for manufacturing a sealed hollow core for use in the manufacturing of a part in composite material;

FIG. 2 schematically illustrates the application for manufacturing a preform and of a sealed hollow core for a sandwich composite material part; and

FIG. 3 schematically illustrates the application of the manufacturing of a part with a complete hollow core in composite material.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

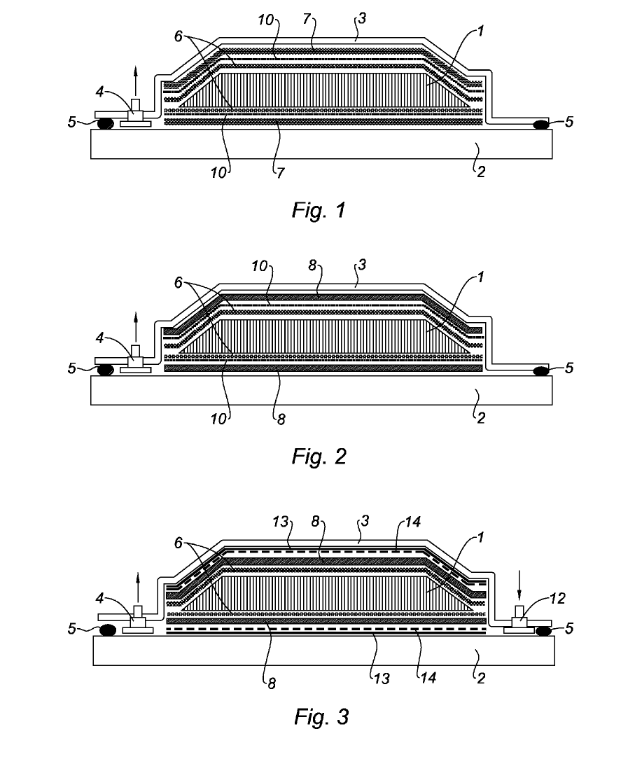

FIG. 1 illustrates the manufacturing of a sealed hollow cellular core 1 for use in the manufacturing of a part in composite material.

To do this, the cellular core 1 is positioned on a mold 2 and covered with a semi rigid membrane 3 forming a counter-mold and associated with means 4 for applying a vacuum to the inner space defined by the mold 2 and the semi rigid membrane 3.

The applied vacuum may typically be a vacuum of less than 100 mbars and in one form greater than 4 mbars.

The semi rigid membrane 3 may be a silicone membrane for example.

Gaskets 5 ensure the seal between the semi rigid membrane 3 and the mold 2.

According to the present disclosure, the cellular core 3 has upper and lower open surfaces which are covered with a polymerizable adhesive film 6, notably of the epoxy adhesive type.

In one form, the polymerizable adhesive film 6 is supported, i.e. reinforced, by a weft, notably in glass fibers.

According to the present disclosure, the adhesive film 6 during its polymerization has properties for blocking the resin which will be used for the manufacturing of the composite material.

The seal of the core is improved by applying on the adhesive film 6 a pressure perpendicular to the adhesive film 6 via the semi rigid membrane 3 by vacuum being applied to it. The pressure is thus also applied on the lower adhesive film 6.

The applied pressure should preferably be as uniform as possible, notably in order to avoid defects of the collapse type of the adhesive film 6 in the cells of the cellular core 3.

The rigidity and thickness characteristics of the semi rigid membrane 3 will allow control of the distribution of the applied pressure on the adhesive film 6. The semi rigid membrane 3 may, if necessary, be replaced with a vacuum tarpaulin if the required pressure properties allow this.

In order to ensure the homogeneity of the applied pressure field, a draining layer 7 is positioned between semi rigid membrane 3 and the adhesive film 6. A second draining layer is positioned between the mold 2 and the lower adhesive film 6.

The draining layer 7 may for example be a felt ply, a woven ply or another porous product. Its rigidity characteristics will also give the possibility of modifying the local pressure parameters, notably always for ensuring the uniformity of the applied pressure field.

The assembly may also be equipped with a separating film 10 aiming at ensuring good separation of the draining layer 7 and of the semi rigid membrane 3 after the operation. The separating film 10 also aims at limiting migration of the adhesive towards the other plies.

FIG. 2 schematically illustrates the manufacturing of a preform for a part in composite material with a sealed hollow core.

The application method of FIG. 2 differs from that of FIG. 1 in that the draining layer 7 is replaced with an assembly of dry fibrous plies 8, i.e. not pre impregnated with resin.

The assembly of fibrous plies 8 may thus be molded into the shape of the cellular core 1 before applying the resin at the same time as said cellular core 1 is sealed.

FIG. 3 schematically illustrates the manufacturing of a part with a complete hollow core 3 in composite material.

Thus, unlike the preceding forms of the present disclosure, the whole of the composite part is made in a single step. To do this, the method and the elements described earlier are completed with means for injecting resins 12 allowing the application of the resin transfer molding cycle.

Thus, a media for distributing the resin 13, should be provided, the separating film 10 being replaced with a removable fabric 14 with view to removing the mold after polymerization of the resin.

In order to prevent the migration of the adhesive towards the ply of dry fibers 8, provision may be made for inserting a nonwoven ply of carbon fibers, the permeability of which at the scale of the fibers is homogeneous. This ply of nonwoven fibers gives the possibility of avoiding preferential take-up points, which would cause degradation in the sealing performances of the adhesive film 6 because of a nonhomogeneous distribution of the adhesive.

Such a ply of nonwoven fibers is also involved in the structure of the assembly and in the improvement of the mechanical properties of the part.

Although the invention has been described with a particular exemplary embodiment, it is quite obvious that it is not by any means limited thereto and that it comprises all the technical equivalents of the means described as well as their combinations if the latter enter the scope of the invention.

What is claimed is:

1. A method for manufacturing a part in composite material with a hollow core comprising the steps of:
applying at least one adhesive layer on an open surface of the hollow core, said method being characterized in that the adhesive layer is a blocking polymerizable adhesive layer having, after polymerization, sealing properties relatively to a resin and capable of preventing its diffusion towards an inside of the hollow core,
proceeding with polymerization of the blocking adhesive layer so as to achieve sealing of the hollow core.

2. The method according to claim 1, characterized in that the blocking adhesive layer is a supported adhesive ply.

3. The method according to claim 2, characterized in that the blocking adhesive layer is supported by a weft of fibers.

4. The method according to claim 3, wherein the fibers are selected from the group consisting of polymer and glass.

5. The method according to claim 1, characterized in that a pressure force is applied at least on the adhesive layer along a direction perpendicular to the adhesive layer.

6. The method according to claim 5, characterized in that the pressure force is applied by applying a vacuum to the assembly to be sealed.

7. The method according to claim 6, characterized in that the vacuum application is carried out by means of at least one membrane used as a counter mold.

8. The method according to claim 5, characterized in that the pressure force is applied on the adhesive layer via at least one draining layer.

9. The method according to claim 1, characterized in that it comprises an additional step of applying onto the adhesive layer at least one ply of fibers.

10. The method according to claim 9, characterized in that the ply of fibers comprises at least one ply of nonwoven fibers, notably carbon fibers, having homogeneous permeability at the fibers.

11. The method according to claim 8, characterized in that the ply of fibers is a ply of dry fibers.

12. The method according to claim 8, characterized in that it comprises an additional step of applying resin according to a molding method by resin transfer, and proceeding with the polymerization of said resin in a casing.

13. The method according to claim 9, characterized in that it comprises an intermediate additional step of pre-forming the ply of fibers.

14. A part manufactured according to the method of claim 1.

15. The part according to claim 14, characterized in that the hollow core is a cellular core.
